(19) United States
(12) Patent Application Publication
(10) Pub. No.: US 2007/0145703 A1
(43) Pub. Date: Jun. 28, 2007

(54) Guidable axle

(76) Inventors: Walter Kogel, Abtsgmuend (DE); Andreas Braun, Schwaebisch Gmuend (DE)

Correspondence Address: JORDAN AND HAMBURG LLP, 122 EAST 42ND STREET, SUITE 4000, NEW YORK, NY, 10168, US

(21) Appl. No.: 11/640,758

(22) Filed: Dec. 18, 2006

(30) Foreign Application Priority Data
Dec. 22, 2005 (DE) 10 2005 061 522.8

(51) Int. Cl. B60G 9/00; B60G 7/00

(52) U.S. Cl. 280/124.116; 280/124.17; 280/771

(57) ABSTRACT

A steering axle for a vehicle has a spring-mounted, rigid axle body which is disposed transversely to the longitudinal axis of the vehicle and at the ends of which steerable wheels are pin-connected. A transmission device is provided for transferring steering motions of a steering member to the steerable wheels. A controlling and/or regulating device detects spring deflection of the rigid axle body and provides a signal for correcting the transfer of the nominal value of the steering angle inputted at the steering member to the steerable wheels, is supplied to a superimposing device in the transmission device as a function of the spring deflection.

### BACKGROUND OF THE INVENTION

The invention relates to a steerable axle for a vehicle.

Steering systems for adjusting the steering angle of steerable wheels at a rigid axle, especially of commercial vehicles, are known. Such steering systems have a steering gear as a transmission connection between a steering handle and steered wheels, which is constructed, for example, as a hydraulically supported ball-and-nut circulating steering transmission. At the same time, a rotational movement at the steering handle is converted into a swiveling movement of a pitman arm of the steering transmission. The pitman arm is hinged over a steering arm with steering arms for adjusting the steering angle of the wheels.

The rigid axle body of the rigid axle is connected over trailing arms, which are mounted at the vehicle body pivotally on either side of the longitudinal axis of the vehicle each over a bearing eye and are connected with the vehicle over suspension struts. Leaf springs may also be used instead of trailing arms. The horizontal distance between the longitudinal axis of the axle body and the bearing eye of the trailing arms or the leaf springs is different from the horizontal distance between the longitudinal distance between the axle body and the link between the pitman arm and the steering arm.

As a result, steering errors arise when the rigid axle body is deflected. These are caused by lift or angle differences from steering arm to trailing arm or leaf spring.

The EP 1 275 574 A2 describes a steerable axle for a commercial vehicle with a spring-mounted, rigid axle body, which is disposed transversely to the axle body and connected with a vehicle body over trailing arms, which are disposed on either side of the longitudinal median plane of the vehicle, and a steering device for transferring steering forces to wheel carriers, which are mounted at either end of the axle body pivotably about assigned steering axels. In order to avoid the above-described steering errors encountered with this steerable axle, the steering device, which is constructed preferably as a steering gear, is fixed at one of the steering arms. The steering device preferably is fixed in the vicinity of a bearing eye of a trailing arm to the latter, so that only slight swiveling motions and, with that, steering errors arise, during the deflection of the axle at the components of the steering device and, in particular, of the steering gear.

The steering precision of this steerable axle is not optimized and, with respect to the overall space required, the axle is unfavorable due to the arrangement of the steering gear and of the steering device at the trailing arm.

The DE 100 58 628 A1 describes a steerable axle for a vehicle with essentially one rigid axle, which is fixed to a vehicle frame and at the ends of which steerable wheels are held pivotably and with a steering gear transmitting the steering motions from a steering wheel over various transmission elements to the wheels. The steering gear is disposed at one side of the vehicle frame, on the one hand, pivotable in the longitudinal direction of the vehicle about a horizontal axis of rotation of a rocker pivot extending transversely to the driving direction. On the other hand, the steering gear is connected directly or indirectly, pivotably, with the rigid axle of the vehicle over additional transmission organs of a further steering connection, matched approximately to the kinematics of the transmission elements. Deflection errors due to horizontal impacts at the steerable axle are effectively suppressed.

The construction of the steerable axle is complex and its steering precision is not optimized.

### SUMMARY OF THE INVENTION

It is an object of the invention-to provide a steerable axle with a spring-mounted rigid axle body, the steering error of which is minimized.

Owing to the fact that the actual spring deflection or the deflection of the rigid axle body relative to a vehicle body is measured by a controlling and regulating device with a displacement sensor and a signal, proportional to the spring deflection, for correcting the nominal steering angle, entered by the steering handle in a superimpositioning device at the transmission device between steering handle and the steerable wheels, is entered, a steering error, caused by different lifts and angles of rotation of a steering arm of the transmission device, is exactly, adaptively compensated for in comparison to trailing arms or leaf springs, with which the rigid axle body is moored to the vehicle body.

The transmission device preferably is a steering gear, which may be coupled to a hydrostatic or electric servo motor.

The superimposing device preferably is disposed, for example, on the low moment side of the steering gear, that is, on the input side of a steering shaft with a steering handle and constructed as a superimposing gear unit with a servo motor.

The signal for correcting the steering angle at the servo motor of the superimposing gear unit can be generated by the controlling and/or regulating device not only as a function of the actually measured spring deflection of the rigid axle body, but may also be pre-calculated as a function of the measured trip parameters, such as the actual value of the steering angle at the steerable wheels.

The steerable axle is constructed as a rigid axle with a pivotable suspension at a vehicle body by means of trailing arms or leaf springs, disposed on either side of the longitudinal axis of the vehicle. The transmission device for transferring steering movements of the steering handle to the steerable wheels is constructed as a steering gear with the rotational movement of a pitman arm, such as a ball-and-nut circulating steering transmission, a pitman arm of the steering transmission being connected over a joint with a steering arm and the steering arm being connected pivotably with knuckle arms. The horizontal distance of the joint between the pitman arm and the steering arm from the longitudinal axis of the rigid axle body is different from the distance between a bearing eye of the trailing arm or leaf spring at the vehicle body from the longitudinal axis of the rigid axle body.

The steering gear may be part of a power assisted or power steering and driven together with a manual steering force, entered over the steering handle, and an actuating force of a hydraulic or electric servo motor. Instead of the steering gear, it may also be appropriate to construct the transmission device as an actuator, in the sense of a power steering, which is controlled directly by the controlling and/or regulating device. In this connection, the superimpositioning device is constructed preferably as an electronic component without mechanical components, such as a microcomputer.

The superimpositioning device may be constructed exclusively as an electric or hydraulic circuit within the controlling and/or regulating device or also formed mechanically as a planetary gearing, as a harmonic drive gear or as a hollow wheel pair system in the sense of an IKONA gear, a correcting angle value, specified by the controlling and special regulating device, being superimposed on the nominal steering angle input at the steering handle.

The steerable axle is suitable for use in a passenger car or commercial vehicle.

The invention is now described in greater detail by means of an example and reproduced by means of the attached drawing.

### BRIEF DESCRIPTION OF THE DRAWING

FIG. 1 shows a diagrammatic longitudinal section through the front section of a vehicle with an inventive, steerable axle.

### DESCRIPTION OF THE PREFERRED EMBODIMENTS

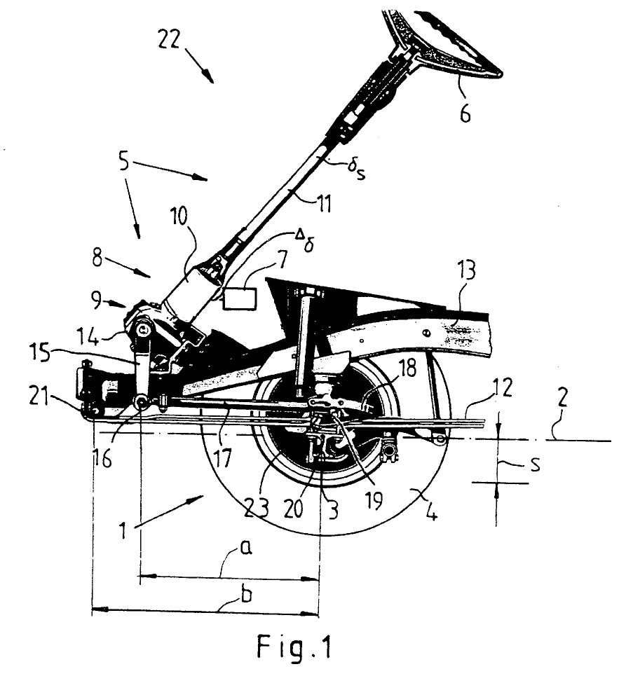

In FIG. 1, a diagrammatic longitudinal section through a front section 22 of a light commercial vehicle is shown, which is equipped with a steerable axle 1 with a rigid axle body 3. Steerable wheels 4, the steering angle of which can be adjusted, mounted over steering knuckles, are fixed to the rigid axle body 3. A nominal steering angle δₛ can be put in at a steering handle 6, which is connected torque proof with a steering shaft 11 and is transferred between the steering handle 6 and the steerable wheels 4 by a transmission device 5. The transmission device 5 has a steering gear 9 with a rotational movement, which is constructed as a hydraulically supported steering gear 14 with a pitman arm 15 and serves to swivel the pitman arm 15. The pitman arm 15 is connected over a joint 16 with a steering arm 17, which is mounted approximately parallel to the longitudinal axis 2 of the vehicle and approximately transversely to the longitudinal axis 20 of the rigid axle body 3. The steering arm 17 transfers the steering movement of the steering handle 6 to knuckle arms 19 and to a steering tie rod 23, which pivotably connects the knuckle arm in a known manner. The steering arm 17 is connected over a joint 18 with the knuckle arm 19.

The rigid axle body 3 is fixed to the vehicle body 13 with, among other things, leaf springs 12, which are disposed on either side of the longitudinal axis 2 of the vehicle. In the driving state of the vehicle, shown in FIG. 1, the leaf springs 12 are deflected. The leaf springs 12 are connected pivotably with the vehicle body 13 each at a bearing eye 21.

The distance “a” of the axis of the joint 16 between the pitman arm 15 and the steering arm 17 from the longitudinal axis 20 of the rigid axle body 3 is less than the distance “b” of the bearing eye 21 from the longitudinal axis 20 of the rigid axle body 3, as a result of which, when the leaf springs 12 are deflected, path differences and angle differences between the leafs springs 12 and the steering arm 17 arise, which lead to undesirable steering movements.

To compensate for these undesired steering movements, the spring path “s” of the rigid axle body 3 is measured and detected by a controlling and/or regulating device 7 and converted into an adjusting signal Δ_{δ}, so that the superimposing device 8, which preferably is constructed as a superimposing gear unit 10 that is driven by a servo motor, is in a position to input a correction angle into the low moment side of the steering shaft 11.

### List of Reference Symbols

| | |
|---|---|
| 1 | Steerable axle |
| 2 | Longitudinal axle of vehicle |
| 3 | Axle body, rigid |
| 4 | Wheel, steerable |
| 5 | Transmission device |
| 6 | Steerable handle |
| 7 | Controlling and/or regulating device |
| 8 | Superimposing device |
| 9 | Steering gear |
| 10 | Superimposing gear |
| 11 | Steering shaft |
| 12 | Leaf spring |
| 13 | Vehicle body |
| 14 | Steering gear with pitman arm |
| 15 | Pitman arm |
| 16 | Joint |
| 17 | Steering arm |
| 18 | Joint |
| 19 | Knuckle arm |
| 20 | Longitudinal axis |
| 21 | Bearing eye |
| 22 | Front section |
| 23 | Steering tie rod |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| s | Spring deflection |
| Δ_{δ} | Signal |
| a | Distance |
| b | Distance |
| δₛ | Nominal value of steering angle |

1. Steerable axle for a vehicle comprising a spring-mounted, rigid axle body, which is disposed transversely to a longitudinal axis of the vehicle, said rigid axle body having ends at which steerable wheels are pin-connected, a transmission device for transferring steering motions of a steering to the steerable wheels a controlling and/or regulating device for detecting spring deflection of the rigid axle body and providing a signal (Δ_{δ}) for correcting the transfer of the nominal value of the steering angle (δₛ) inputted at the steering member to the steerable wheels, is supplied to a superimposing device in the transmission device as a function of the spring deflection.

2. The steerable axle of claim 1, wherein the transmission device comprises a steering gear.

3. The steerable axle of claim 1, wherein the superimposing device is a superimposing gear, which is disposed at a steering shaft of the vehicle.

4. The steerable axle of claim 1, wherein the superimposing device is disposed between the transmission device and the steering member.

5. The steerable axle of claim 1, wherein the signal (Δ_{δ}) is calculated by the controlling and/or regulating device as a function of the actual value of the steering angle and further vehicle-specific and/or trip-specific signals.

6. The steerable axle of claim 1, wherein the rigid axle body is connected with a vehicle body over trailing arms and/or leaf springs disposed on either side of the longitudinal axis of the vehicle.

7. The steerable axle of claim 6, wherein the transmission device for transferring steering movements of the steering member to the steerable wheels is a steering gear with the rotational movement of a pitman arm, the pitman arm being connected over a joint with a steering arm and the steering arm being connected with a joint with a knuckle arm.

8. The steerable axle of claim 7, wherein the joint between the pitman arm and the steering arm is disposed at a distance from the longitudinal axis of the rigid axle body, which is different from the distance of a bearing eye of the trailing arms or leaf springs from the longitudinal axis of the rigid axle body.

9. The steerable axle of claim 1, wherein the transmission device for transferring steering movements of the steering member to the steerable wheels is part of a power-assisted or power steering system.

10. The steerable axle of, claim 1, wherein the superimposing device is a planetary gearing, a harmonic drive gear, a hollow wheel pair system, or an electric or hydraulic control element.

11. The steerable axle of claim 1, wherein the steerable axle is part of a passenger car or a commercial vehicle.
